(19) United States
(12) Patent Application Publication
(10) Pub. No.: US 2026/0160365 A1
(43) Pub. Date: Jun. 11, 2026

(54) PIPE JOINT FITTING

(71) Applicant: THE YOKOHAMA RUBBER CO., LTD., HIRATSUKA-SHI, KANAGAWA (JP)

(72) Inventor: Naoki BAN, HIRATSUKA-SHI, KANAGAWA (JP)

(21) Appl. No.: 19/121,575

(22) PCT Filed: Aug. 8, 2023
(86) PCT No.: PCT/JP2023/028872

§ 371 Date: Apr. 16, 2025

(30) Foreign Application Priority Data
Dec. 23, 2022 (JP) 2022-206750

(51) Int. Cl. F16L 27/12

(52) U.S. Cl. CPC F16L 27/1274; F16L 27/125

(57) ABSTRACT

Adjusting a length reduces damage to a pipe to be connected and avoids an increase in work man-hours and an increase in costs at a time of assembly. A pipe joint fitting (10A) includes a mouthpiece portion (22A) (first joint fitting portion (12)) and a hose joint portion (24A) (second joint portion (14)) and connects fluid passages. The pipe joint fitting (10A) includes a joining mechanism (18) configured to join the mouthpiece portion (22A) and the hose joint portion (24A) while allowing a total length of the mouthpiece portion (22A) and the hose joint portion (24A) to be adjusted with the mouthpiece portion (22A) and the hose joint portion (24A) joined to each other and with the interiors of the first joint fitting portion and the second joint fitting portion in communication with each other. The pipe joint fitting (10A) includes a lock mechanism (20) configured to lock the mouthpiece portion (22A) and the hose joint portion (24A) with a total length thereof adjusted.

### TECHNICAL FIELD

The present invention relates to a pipe joint fitting.

### BACKGROUND ART

As a pipe joint fitting, a known hose joint fitting attached to an end portion of a hose for connecting the hose to a device or the like is provided (see Patent Document 1).

The hose joint fitting includes a nipple and a socket joined to each other, and the nipple and the socket coaxially include a nipple-side cylindrical portion one end of which in an axial direction thereof is open, and a socket-side cylindrical portion positioned on the outer side of the nipple-side cylindrical portion in a radial direction thereof.

The hose joint fitting is attached to the end portion of the hose by inserting the end portion of the hose into an annular space formed between the outer circumferential surface of the nipple-side cylindrical portion and the inner circumferential surface of the socket-side cylindrical portion, and then crimping the socket-side cylindrical portion with a crimping device to integrally attach the socket-side cylindrical portion, the end portion of the hose, and the nipple-side cylindrical portion to one another.

### CITATION LIST

### Patent Literature

Patent Document 1: JP 2014-181789 A

### SUMMARY OF INVENTION

### Technical Problem

When a hose is attached to the pipe joint fitting described above, a hose having a length required for a product such as a hose assembly is selected.

However, since there is a tolerance in the length of the hose, a difference occurs in the length of an assembled product within a permissible range.

A permissible difference in the length at the time of assembling the hose is defined by Japanese Industrial Standards (JIS). For example, if the length (mm) of the assembly is “1000 or more and less than 2000”, the permissible difference is defined to be 0 mm or more and 20 mm or less.

Therefore, for example, in a case where a plurality of hoses (pipes) are accommodated in Cableveyor (trade name) and caused to operate, if the lengths of the individual hoses are different from one another, paths traced by the pipes also become different among the individual hoses. Then, the hose may not bend as expected, come into contact with, and rub against Cableveyor (trade name), or an unbearable stress may be applied to the hose and the pipe may be damaged.

On the other hand, when the permissible difference in the length of the product is reduced, more accurate measurements are required as a special management product at the time of the assembly, which results in an increase in work man-hours and an increase in costs.

The present invention has been made in light of the above-described circumstances, and an object of the present invention is to provide a pipe joint fitting that suppresses damage to a pipe to be connected by adjusting the length of the pipe joint fitting, and that prevents an increase in work man-hours and an increase in costs at the time of assembly.

### Solution to Problem

An embodiment of the present invention to achieve the object described above is a pipe joint fitting including a first joint fitting portion and a second joint fitting portion and connecting fluid passages. The pipe joint fitting may include a joining mechanism configured to join the first joint fitting portion and the second joint fitting portion while allowing a total length of the first joint fitting portion and the second joint fitting portion to be adjusted with the first joint fitting portion and the second joint fitting portion joined to each other and with interiors of the first joint fitting portion and the second joint fitting portion in communication with each other.

An embodiment of the present invention may include a lock mechanism configured to lock the first joint fitting portion and the second joint fitting portion with a total length thereof adjusted.

In an embodiment of the present invention, a male thread tube may be disposed projecting from one of an end portion of the second joint fitting portion facing the first joint fitting portion or an end portion of the first joint fitting portion facing the second joint fitting portion, a female thread engageable with the male thread tube may be formed at the other of the end portions, and the joining mechanism may include the male thread tube and the female thread.

In an embodiment of the present invention, a lock nut may be engaged with the male thread tube, and a lock mechanism configured to lock the first joint fitting portion and the second joint fitting portion with a total length thereof adjusted may include the lock nut.

In an embodiment of the present invention, the pipe joint fitting may include an adapter having a cylindrical shape and interposed between the first joint fitting portion and the second joint fitting portion, a rotation operation unit configured to rotate the adapter may be provided at an outer circumferential portion of an intermediate portion of the adapter in a longitudinal direction, male threads in opposite directions from each other may be formed at the outer circumferential portion of the adapter on both sides in the longitudinal direction a female thread to be engaged with one of the male threads in the opposite directions from each other may be formed at an end portion of the second joint fitting portion facing the first joint fitting portion, a female thread to be engaged with the other of the male threads in the opposite directions from each other may be formed at an end portion of the first joint fitting portion facing the second joint fitting portion, and the joining mechanism may include the rotation operation unit, the male threads in the opposite directions from each other, and the female threads.

In an embodiment of the present invention, a lock nut may be engaged with each of the male threads in the opposite directions from each other, and a lock mechanism configured to lock the first joint fitting portion and the second joint fitting portion with a total length thereof adjusted may include the lock nut.

In an embodiment of the present invention, the pipe joint fitting may include an adapter having a cylindrical shape and interposed between the first joint fitting portion and the second joint fitting portion, male thread tubes formed with male threads in opposite directions from each other may be each disposed projecting from an end portion of the second joint fitting portion facing the first joint fitting portion and an end portion of the first joint fitting portion facing the second joint fitting portion, a rotation operation unit configured to rotate the adapter may be provided at an outer circumferential portion of the adapter, female threads in opposite directions from each other engaged with the male threads may be formed at an inner circumferential portion of the adapter on both sides in a longitudinal direction, and the joining mechanism may include the male thread tubes and the adapter.

In an embodiment of the present invention, a lock nut may be engaged with each of the male threads in the opposite directions from each other, and a lock mechanism configured to lock the first joint fitting portion and the second joint fitting portion with a total length thereof adjusted may include the lock nuts.

In an embodiment of the present invention, the first joint fitting portion may be a mouthpiece portion to be connected to a device side, and the second joint fitting portion may be a hose joint portion to which a hose is connected.

In an embodiment of the present invention, the first joint fitting portion and the second joint fitting portion may be hose joint portions to which hoses are connected.

In an embodiment of the present invention, the first joint fitting portion and the second joint fitting portion may be mouthpiece portions to be connected to a device side.

### Advantageous Effects of Invention

An embodiment of the present invention is provided with a joining mechanism configured to join the first joint fitting portion and the second joint fitting portion while allowing the total length of the first joint fitting portion and the second joint fitting portion to be adjusted, thus allowing the length of a pipe joint fitting to be adjusted. This advantageously reduces damage to a pipe to be connected and avoids an increase in work man-hours and an increase in costs at the time of assembly. Releasing the joining of the joining mechanism allows the first joint fitting portion and the second joint fitting portion to be separated from each other, advantageously improving convenience.

The configuration of providing a lock mechanism configured to lock the first joint fitting portion and the second joint fitting portion with a total length thereof adjusted allows the pipe joint fitting to be fixed at a desired length, advantageously reducing damage to the pipe to be connected.

The configuration in which a male thread tube is disposed projecting from one of an end portion of the second joint fitting portion facing the first joint fitting portion or an end portion of the first joint fitting portion facing the second joint fitting portion, a female thread engageable with the male thread tube is formed at the other of the end portions, and the joining mechanism includes the male thread tube and the female thread advantageously constitutes the length-adjustable pipe joint fitting in a simple manner.

The configuration in which the lock mechanism includes a lock nut engaged with the male thread tube advantageously constitutes the lock mechanism in a simple manner.

The configuration in which the pipe joint fitting includes an adapter having a cylindrical shape and interposed between the first joint fitting portion and the second joint fitting portion, a rotation operation unit is provided at an outer circumferential portion of an intermediate portion of the adapter in a longitudinal direction, male threads in opposite directions from each other are formed at the outer circumferential portion of the adapter on both sides in the longitudinal direction, a female thread to be engaged with one of the male threads in the opposite directions from each other is formed at an end portion of the second joint fitting portion facing the first joint fitting portion, a female thread to be engaged with the other of the male threads in the opposite directions from each other is formed at an end portion of the first joint fitting portion facing the second joint fitting portion, and the joining mechanism includes the rotation operation unit, the male threads in the opposite directions from each other, and the female threads advantageously constitutes the length-adjustable pipe joint fitting in a simple manner.

The configuration in which the lock mechanism configured to lock the first joint fitting portion and the second joint fitting portion with the total length thereof adjusted includes the lock nut engaged with each of the male threads in the opposite directions from each other advantageously constitutes the lock mechanism in a simple manner.

The configuration in which the pipe joint fitting includes an adapter having a cylindrical shape and interposed between the first joint fitting portion and the second joint fitting portion, male thread tubes are each disposed projecting from an end portion of the second joint fitting portion facing the first joint fitting portion and an end portion of the first joint fitting portion facing the second joint fitting portion, the male thread tubes are formed with respective male threads in opposite directions from each other, a rotation operation unit is provided at an outer circumferential portion of the adapter, female threads in opposite directions from each other engaged with the male threads are formed at an inner circumferential portion of the adapter on both sides in a longitudinal direction, and the joining mechanism includes the male thread tubes and the adapter advantageously constitutes the length-adjustable pipe joint fitting in a simple manner.

The configuration in which the lock mechanism configured to lock the first joint fitting portion and the second joint fitting portion with the total length thereof adjusted includes the lock nut engaged with each of the male threads in the opposite directions from each other advantageously constitutes the lock mechanism in a simple manner.

The configuration in which the first joint fitting portion is constituted by a mouthpiece portion to be connected to a device side and the second joint fitting portion is constituted by a hose joint portion to which a hose is connected allows the distance between the device and the hose to be adjusted.

The configuration in which the first joint fitting portion and the second joint fitting portion are constituted by hose joint portions to which the hose is connected allows the distance between the hoses to be adjusted.

The configuration in which the first joint fitting portion and the second joint fitting portion are constituted by mouthpiece portions to be connected to a device side allows the distance between the devices to be adjusted.

### BRIEF DESCRIPTION OF DRAWINGS

FIG. 1 is a side view illustrating a pipe joint fitting according to a first embodiment with part thereof omitted, in a state where the pipe joint fitting is elongated to a maximum extent.

FIG. 2 is a side view illustrating the pipe joint fitting according to the first embodiment with part thereof omitted, in a state where the pipe joint fitting is shortened to a maximum extent.

FIG. 3 is an exploded view of the pipe joint fitting according to the first embodiment.

FIG. 4 is a side view illustrating a pipe joint fitting according to a second embodiment with part thereof omitted.

FIG. 5 is a side view illustrating a pipe joint fitting according to a third embodiment with part thereof omitted.

FIG. 6 is an exploded view of the pipe joint fitting according to the third embodiment.

FIG. 7 is a side view illustrating a pipe joint fitting according to a first modified example of the third embodiment with part thereof omitted.

FIG. 8 is a side view illustrating a pipe joint fitting according to a second modified example of the third embodiment with part thereof omitted.

FIG. 9 is a side view illustrating a pipe joint fitting according to a fourth embodiment with part thereof omitted.

FIG. 10 is an exploded view of the pipe joint fitting according to the fourth embodiment.

FIG. 11 is a side view illustrating a pipe joint fitting according to a first modified example of the fourth embodiment with part thereof omitted.

FIG. 12 is a side view illustrating a pipe joint fitting according to a second modified example of the fourth embodiment with part thereof omitted.

### DESCRIPTION OF EMBODIMENTS

### First Embodiment

Hereinafter, embodiments of the present invention will be described with reference to the drawings.

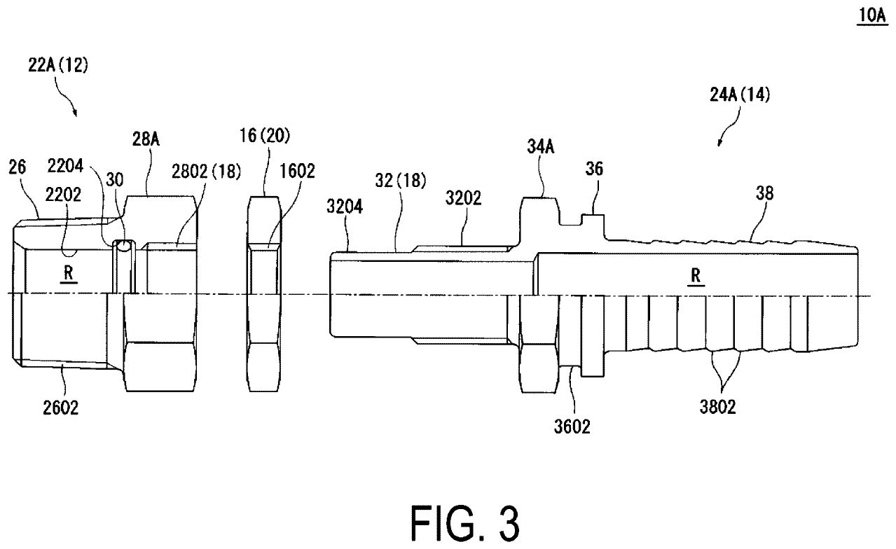

As illustrated in FIG. 3, a pipe joint fitting 10A includes a first joint fitting portion 12, a second joint fitting portion 14, and a lock nut 16. The first joint fitting portion 12 and the second joint fitting portion 14 connect fluid passages R, which are respectively provided in the first joint fitting portion 12 and the second joint fitting portion 14 so as to penetrate therethrough.

The first joint fitting portion 12, the second joint fitting portion 14, and the lock nut 16 are constituted separately.

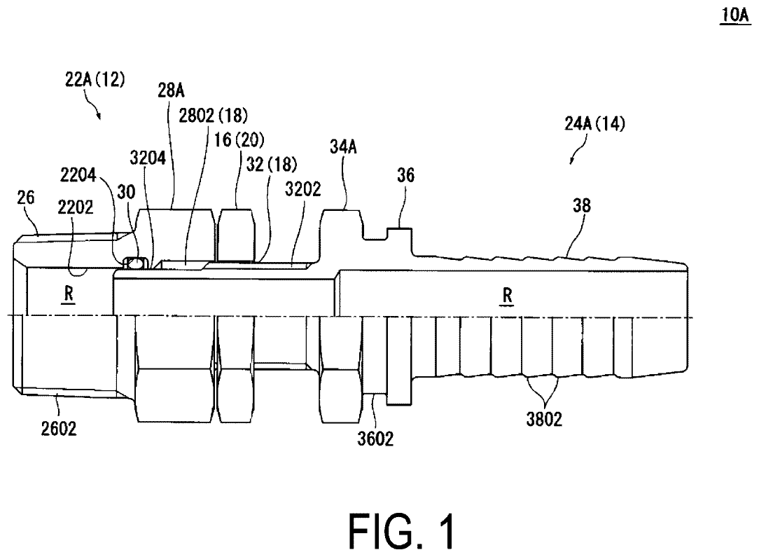

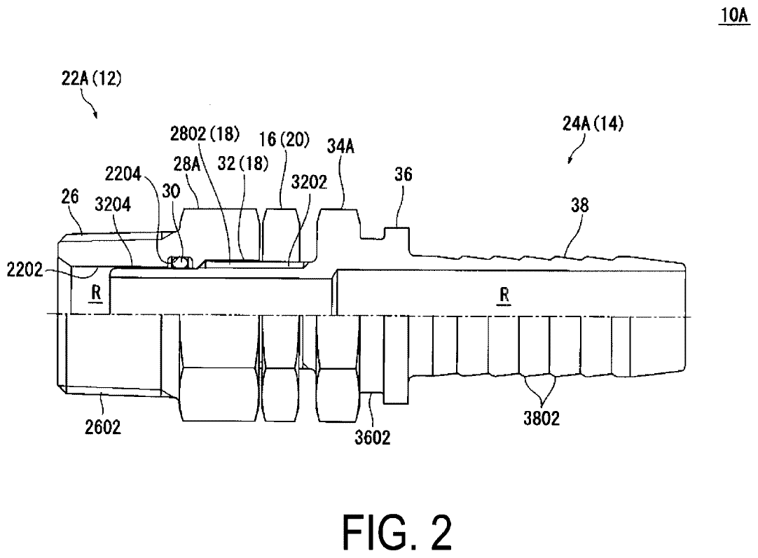

As illustrated in FIGS. 1 and 2, the pipe joint fitting 10A includes a joining mechanism 18 that joins the first joint fitting portion 12 and the second joint fitting portion 14 while allowing the distance between the first joint fitting portion 12 and the second joint fitting portion 14 to be adjusted with the fluid passages R inside the first joint fitting portion 12 and the second joint fitting portion 14 in communication with each other.

Furthermore, the pipe joint fitting 10A includes a lock mechanism 20 that locks the first joint fitting portion 12 and the second joint fitting portion 14 with a total length therebetween adjusted.

In the pipe joint fitting 10A of the present embodiment, the first joint fitting portion 12 is constituted by a mouthpiece portion 22A to be connected to a device side, and the second joint fitting portion 14 is constituted by a hose joint portion 24A to be connected to an end portion of a hose. Thus, fluid flowing inside the hose is appropriately supplied to a device or appropriately discharged from the device.

The pipe joint fitting 10A is made of metal such as soft steel, and, for example, STKM (carbon steel pipe for machine structural use), free-cutting steel, carbon steel, aluminum, brass, stainless steel, or the like. The pipe joint fitting 10A is subjected to a surface treatment such as a chromate treatment in order to improve corrosion resistance and suppress adhesion of dirt.

The mouthpiece portion 22A is constituted by a tube portion 26 and a mouthpiece-side nut portion 28A being coaxially arranged in an axial direction of the mouthpiece portion 22A, and the fluid passage R is formed penetrating through the interiors thereof.

The tube portion 26 is a cylindrical member detachably connected to the device as appropriate, and a male thread 2602 is formed at an outer circumferential portion of the tube portion 26 so that the tube portion 26 can be attached to the device. Note that various known structures may be applied as the structure of the tube portion 26 as long as the tube portion 26 can be attached to the device.

The mouthpiece-side nut portion 28A is a hexagonal nut and is provided adjacent to the tube portion 26.

At the inner circumferential surface of an end portion of the mouthpiece portion 22A (first pipe joint fitting portion 12) facing the hose joint portion 24A (second pipe joint fitting portion 14), that is, an end portion of the mouthpiece-side nut portion 28A positioned opposite to the tube portion 26, a female thread 2802 that can be engaged with a male thread tube 32 of the hose joint portion 24A is formed.

An annular groove 2204 is formed at an inner circumferential surface 2202, of the mouthpiece portion 22A, forming the fluid passage R, and an O-ring 30 is fitted in the annular groove 2204. The O-ring 30 of the present embodiment is provided adjacent to the female thread 2802.

The hose joint portion 24A is constituted by the male thread tube 32, a joint-side nut portion 34A, a flange portion 36, and a cylindrical portion 38 being coaxially arranged in an axial direction of the hose joint portion 24A, and the fluid passage R is formed penetrating through the interiors thereof in the same manner as in the mouthpiece portion 22A.

The joint-side nut portion 34A has a hexagonal pillar-like shape and is provided at an intermediate portion of the hose joint portion 24A in the axial direction thereof. Note that the joint-side nut portion 34A is optionally replaced with a large diameter portion constituted by a circumferential surface, or the like.

The flange portion 36 is provided adjacent to the joint-side nut portion 34A, and a groove portion 3602 to which a socket (not illustrated) is attached is formed between the flange portion 36 and the joint-side nut portion 34A.

The socket (not illustrated) has a cylindrical shape, is provided on the outer side in the radial direction of the cylindrical portion 38, and is attached to the hose joint portion 24A by an attachment portion of the socket, formed at an end portion thereof in the axial direction, being crimped to the groove portion 3602.

The cylindrical portion 38 is a portion inserted into the inner circumferential surface of the hose. The cylindrical portion 38 is disposed projecting from the flange portion 36, and when the hose is inserted, the flange portion 36 can come into contact with an end portion of the hose.

At the outer circumferential surface of the cylindrical portion 38, a plurality of fixing uneven portions 3802 extending in the circumferential direction are formed at intervals in the axial direction.

When the socket is attached to the hose joint portion 24A, an annular space into which the end portion of the hose is inserted is formed between an outer circumferential portion of the cylindrical portion 38 and an inner circumferential portion of the socket. By inserting the hose into the annular space and crimping the socket using a crimping device, the end portion of the hose is integrally attached to the hose joint portion 24A.

Note that, instead of attaching the socket to the hose joint portion 24A, the end portion of the hose may be inserted into the cylindrical portion 38, and the end portion of the hose may be attached to the hose joint portion 24A by fastening the hose with a band.

The male thread tube 32 is disposed projecting from an end portion of the hose joint portion 24A (second joint fitting portion 14) facing the mouthpiece portion 22A (first joint fitting portion 12), that is, from an end portion of the joint-side nut portion 34A on the side opposite to the flange portion 36.

The male thread tube 32 has a cylindrical shape, and a male thread 3202 that can be engaged with the female thread 2802 is formed at an outer circumferential portion of the male thread tube 32 on the joint-side nut portion 34A side.

A front end outer circumferential surface 3204 positioned on the front end side of the male thread tube 32 is formed as a smooth surface without unevenness, and the outer diameter of the front end outer circumferential surface 3204 is formed in a dimension insertable into the inner circumferential surface 2202 of the mouthpiece portion 22A.

FIG. 1 illustrates a state where the male thread 3202 and the female thread 2802 are slightly engaged with each other and the pipe joint fitting 10A is elongated to a maximum extent in the axial direction of the mouthpiece portion 22A and the axial direction of the hose joint portion 24A, that is, in the axial direction of the pipe joint fitting 10A, in other words, a state where the length of the pipe joint fitting 10A is maximized. FIG. 2 illustrates a state where the male thread 3202 and the female thread 2802 are engaged with each other to a maximum extent and the pipe joint fitting 10A is shortened to a maximum extent in the axial direction of the pipe joint fitting 10A, in other words, a state where the length of the pipe joint fitting 10A is minimized.

In other words, with the pipe joint fitting 10A, the length of the pipe joint fitting 10A in the axial direction, that is, the length of the pipe joint fitting 10A can be adjusted within a range in which the male thread 3202 and the female thread 2802 can be engaged with each other.

As illustrated in FIGS. 1 and 2, the lock nut 16 is engaged with the male thread tube 32. Specifically, the male thread 3202 of the male thread tube 32 is engaged with a female thread 1602 formed at the lock nut 16.

The joining mechanism 18 of the present embodiment that joins the mouthpiece portion 22A and the hose joint portion 24A includes the male thread tube 32 and the female thread 2802.

The lock mechanism 20 of the present embodiment includes the lock nut 16.

Next, a method for joining the mouthpiece portion 22A (first joint fitting portion 12) and the hose joint portion 24A (second joint fitting portion 14) will be described.

When joining the mouthpiece portion 22A and the hose joint portion 24A, first, the lock nut 16 is engaged with the male thread 3202 of the male thread tube 32 of the hose joint portion 24A and positioned in the vicinity of the joint-side nut portion 34A.

Subsequently, the male thread tube 32 of the hose joint portion 24A is caused to face the mouthpiece-side nut portion 28A of the mouthpiece portion 22A, and the axial directions of the mouthpiece portion 22A and the hose joint portion 24A are aligned with each other.

Then, when the front end of the male thread tube 32 of the hose joint portion 24A is inserted into the mouthpiece portion 22A, the O-ring 30 comes into elastic contact with the front end outer circumferential surface 3204, and a gap between the front end outer circumferential surface 3204 and the inner circumferential surface 2202 of the mouthpiece portion 22A is sealed by the O-ring 30, thereby preventing leakage of fluid from occurring between the mouthpiece portion 22A and the hose joint portion 24A.

Note that the term “sealed” refers to a liquid-tight state where leakage of a liquid such as oil is prevented.

When the male thread tube 32 is inserted into the mouthpiece portion 22A and the male thread 3202 of the male thread tube 32 reaches the female thread 2802 of the mouthpiece portion 22A, the joint-side nut portion 34A is operated to rotate the hose joint portion 24A about the axial center thereof, thereby appropriately engaging the male thread 3202 with the female thread 2802.

When the male thread 3202 is appropriately engaged with the female thread 2802, the mouthpiece portion 22A is connected to the device, and the hose is attached to the hose joint portion 24A.

Then, by operating the joint-side nut portion 34A, the hose joint portion 24A is rotated to adjust the total length of the mouthpiece portion 22A and the hose joint portion 24A, and then, the lock nut 16 is reversely rotated to be returned to a position at which the lock nut 16 comes into contact with the mouthpiece portion 22A so as to fix the pipe joint fitting 10A at a desired length.

In the present embodiment, the total length of the mouthpiece portion 22A and the hose joint portion 24A is adjustable within the range in which the male thread 3202 and the female thread 2802 can be engaged with each other.

Accordingly, the distance from the device to the hose can be adjusted to a desired length.

As described above, the pipe joint fitting 10A of the first embodiment is provided with the joining mechanism 18 that joins the mouthpiece portion 22A and the hose joint portion 24A while allowing the total length of the mouthpiece portion 22A and the hose joint portion 24A to be adjusted with the interiors of the separated mouthpiece portion 22A (first joint fitting portion 12) and hose joint portion 24A (second joint fitting portion 14) in communication with each other, thus allowing the length of the pipe joint fitting 10A to be adjusted. This advantageously reduces damage to a pipe to be connected and avoids an increase in work man-hours and an increase in costs at the time of assembly. Releasing the joining of the joining mechanism 18 allows the mouthpiece portion 22A and the hose joint portion 24A to be separated from each other, advantageously improving convenience.

The configuration of providing the lock mechanism 20 configured to lock the mouthpiece portion 22A and the hose joint portion 24A with the total length thereof adjusted allows the pipe joint fitting 10A to be fixed at a desired length, advantageously reducing damage to the pipe to be connected.

The configuration in which the male thread tube 32 is disposed projecting from the end portion of the hose joint portion 22A facing the mouthpiece portion 24A, the female thread 2802 that can be engaged with the male thread tube 32 is formed at the end portion of the mouthpiece portion 24A facing the hose joint portion 22A, and the joining mechanism 18 includes the male thread tube 32 and the female thread 2802 advantageously constitutes the length-adjustable pipe joint fitting 10A in a simple manner.

The configuration in which the lock mechanism 20 includes the lock nut 16 engaged with the male thread tube 32, advantageously constitutes the lock mechanism 20 in a simple manner.

The configuration in which the first joint fitting portion 18 is constituted by the mouthpiece portion 22A to be connected to the device side and the second joint fitting portion 14 is constituted by the hose joint portion 24A to be connected to the hose allows the distance between the device and the hose to be adjusted.

### Second Embodiment

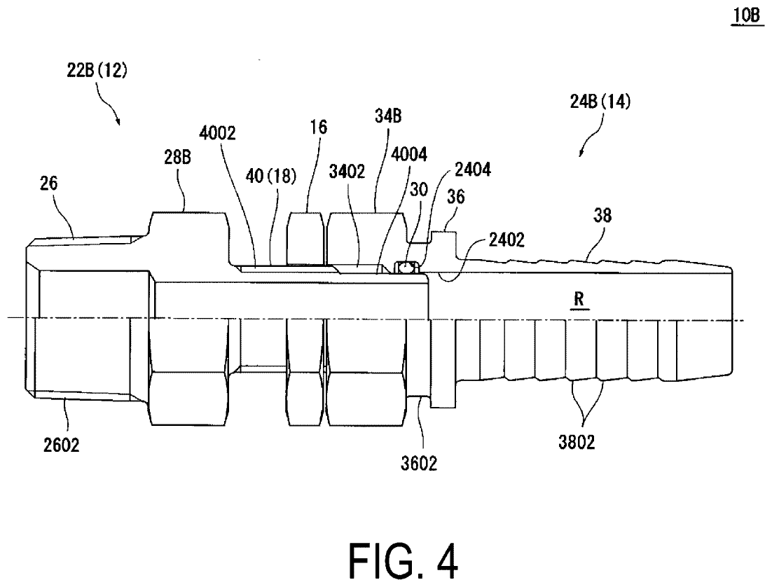

A pipe joint fitting 10B of a second embodiment will be described with reference to FIG. 4.

In the first embodiment, the female thread 2802 is formed at the mouthpiece portion 22A and the male thread 3202 is formed at the hose joint portion 24A, whereas in the second embodiment, a male thread 4002 is formed at a mouthpiece portion 22B and a female thread 3402 is formed at a hose joint portion 24B.

Note that, in the embodiments described below, the same sections and members as those of the first embodiment will be denoted by the same reference signs, the descriptions thereof will be omitted, and different sections from the first embodiment will be mainly described.

In the pipe joint fitting 10B of the present embodiment, the first joint fitting portion 12 is constituted by the mouthpiece portion 22B to be connected to the device side, and the second joint fitting portion 14 is constituted by the hose joint portion 24B to be connected to the end portion of the hose.

The mouthpiece portion 22B is constituted by the tube portion 26, a mouthpiece-side nut portion 28B, and a male thread tube 40 being coaxially arranged in an axial direction of the mouthpiece portion 22B, and the fluid passage R is formed penetrating through the interiors thereof.

The mouthpiece-side nut portion 28B has a hexagonal pillar-like shape and is provided adjacent to the tube portion 26.

The male thread tube 40 is disposed projecting from an end portion of the mouthpiece portion 22B (first joint fitting portion 12) facing the hose joint portion 24B (second joint fitting portion 14), that is, the male thread tube 40 is disposed projecting from an end portion of the mouthpiece-side nut portion 28B on the side opposite to the tube portion 26.

The male thread tube 40 has a cylindrical shape, and a male thread 4002 that can be engaged with the female thread 3402 of a joint-side nut portion 34B is formed at an outer circumferential portion of the male thread tube 40 on the male thread-side nut portion 28B side.

A front end outer circumferential surface 4004 positioned on the front end side of the male thread tube 40 is formed as a smooth surface without unevenness, and the outer diameter of the front end outer circumferential surface 4004 is formed in a dimension insertable into an inner circumferential surface 2402 of the hose joint portion 24B.

The lock nut 16 is engaged with the male thread tube 40. Specifically, the male thread 4002 of the male thread tube 40 is engaged with the female thread 1602 (see FIG. 3) formed at the lock nut 16.

The hose joint portion 24B is constituted by the joint-side nut portion 34B, the flange portion 36, and the cylindrical portion 38 being coaxially arranged in an axial direction of the hose joint portion 24B, and the fluid passage R is formed penetrating through the interiors of thereof in the same manner as in the mouthpiece portion 22B.

The joint-side nut portion 34B is a hexagonal nut and is provided adjacent to the flange portion 36 via the groove portion 3602.

The female thread 3402 that can be engaged with the male thread tube 40 of the mouthpiece portion 22B is formed at the inner circumferential surface of an end portion of the hose joint portion 24B (second joint fitting portion 14) facing the mouthpiece portion 22B (first joint fitting portion 12), that is, an end portion of the hose joint portion 24B positioned opposite to the flange portion 36 of the joint-side nut portion 34B.

An annular groove 2404 is formed at an inner circumferential surface 2402, of the hose joint portion 24B, forming the fluid passage R, and the O-ring 30 is fitted in the annular groove 2404. The O-ring 30 of the present embodiment is provided adjacent to the female thread 3402.

In the pipe joint fitting 10B, the male thread 4002 is provided at the mouthpiece portion 22B and the female thread 3402 is provided at the hose joint portion 24B, but a method for joining the mouthpiece portion 22B (first joint fitting portion 12) and the hose joint portion 24B (second joint fitting portion 14) is the same as that of the first embodiment.

The same effects as those of the first embodiment are also achieved by the pipe joint fitting 10B of the second embodiment described above.

In the first embodiment described above, the male thread 3202 formed at the hose joint portion 22A is engaged with the female thread 2802 formed at the mouthpiece portion 24A to join the mouthpiece portion 22A and the hose joint portion 24A, and in the second embodiment, the male thread 4002 formed at the mouthpiece portion 22B is engaged with the female thread 3402 formed at the hose joint portion 24B to join the mouthpiece portion 22B and the hose joint portion 24B. However, the combination of the first joint fitting portion 12 and the second joint fitting portion 14 may be other combinations.

Specifically, for example, both the first joint fitting portion and the second joint fitting portion may be hose joint portions, and may be configured such that a male thread formed at one of the hose joint portions is engaged with a female thread formed at the other hose joint portion to join the two hose joint portions. Accordingly, the distance between the hoses can be adjusted.

For example, both the first joint fitting portion and the second joint fitting portion may be mouthpiece portions, and may be configured such that a male thread formed at one of the mouthpiece portions is engaged with a female thread formed at the other mouthpiece portion to join the two mouthpiece portions. Accordingly, the distance between devices can be adjusted.

As described above, the pipe joint fittings 10A and 10B of the above-described embodiments, can connect, by changing the combination of the first joint fitting portion 12 and the second joint fitting portion 14 in accordance with an intended application, a device and a hose, hoses to each other, or devices to each other with the length of the pipe joint fitting adjusted, advantageously improving convenience.

### Third Embodiment

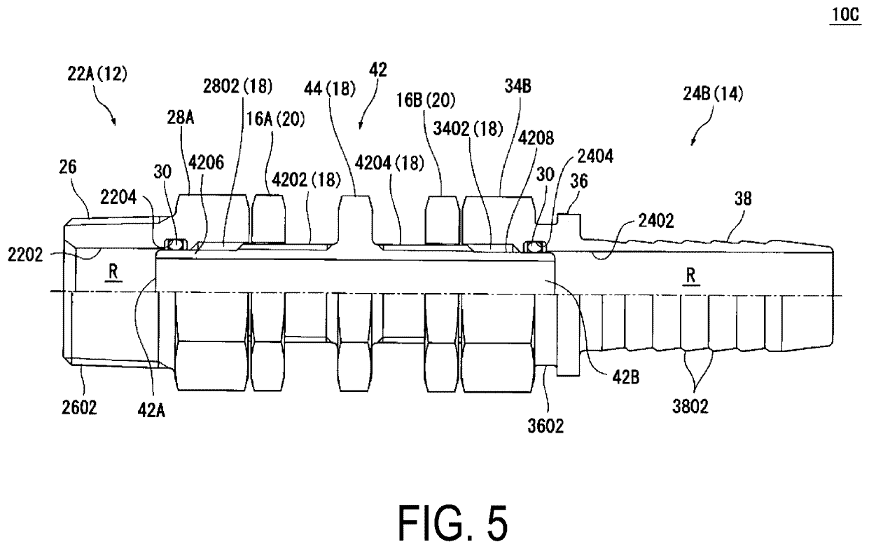

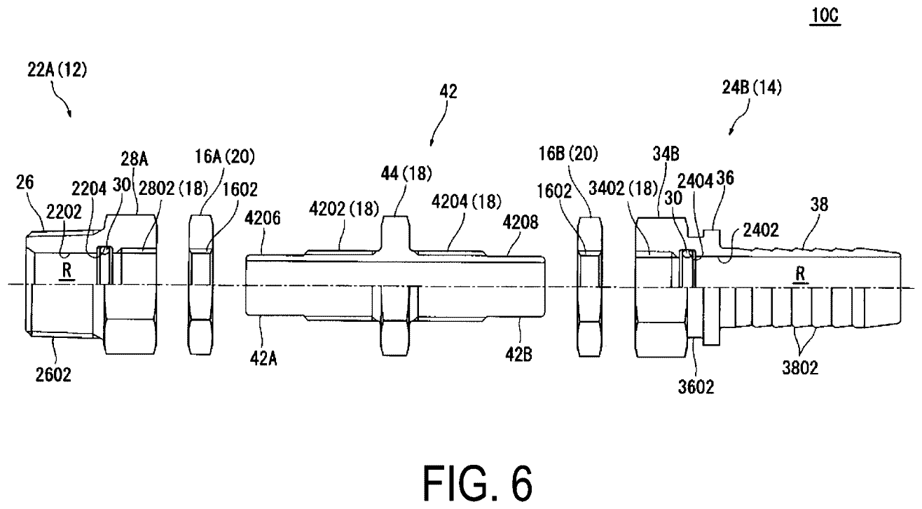

A pipe joint fitting 10C of a third embodiment will be described with reference to FIGS. 5 and 6.

In the first embodiment, the male thread 3202 formed at the hose joint portion 24A is engaged with the female thread 2802 formed at the mouthpiece portion 22A to join the mouthpiece portion 22A and the hose joint portion 24A, but in the third embodiment, the mouthpiece portion 22A and the hose joint portion 24B are joined to each other via an adapter 42 provided between the mouthpiece portion 22A and the hose joint portion 24B.

The pipe joint fitting 10C includes the first joint fitting portion 12, the second joint fitting portion 14, the adapter 42, and lock nuts 16A and 16B, which are separated from each other as illustrated in FIG. 6.

In the pipe joint fitting 10C of the present embodiment, the first joint fitting portion 12 is constituted by the mouthpiece portion 22A to be connected to the device side, and the second joint fitting portion 14 is constituted by the hose joint portion 24B to be connected to the end portion of the hose.

The adapter 42 has a cylindrical shape and is interposed between the mouthpiece portion 22A and the hose joint portion 24B.

A rotation operation unit 44, which has a hexagonal pillar-like shape and is configured to rotate the adapter 42, is provided at an outer circumferential portion of an intermediate portion of the adapter 42 in the longitudinal direction (axial direction).

Male threads 4202 and 4204 in opposite directions from each other are formed at the outer circumferential portion of the adapter 42 on both sides in the longitudinal direction.

Specifically, the male threads 4202 and 4204 are formed at the outer circumferential portion of the adapter 42 on both sides in the longitudinal direction and on the rotation operation unit 44 side.

End portion outer circumferential surfaces 4206 and 4208 positioned at both end portions of the adapter 42 in the longitudinal direction are formed as smooth surfaces without unevenness.

The outer diameter of the end portion outer circumferential surface 4206 is formed to have a dimension insertable into the inner circumferential surface 2202 of the mouthpiece portion 22A, and the outer diameter of the end portion outer circumferential surface 4208 is formed to have a dimension insertable into the inner circumferential surface 2402 of the hose joint portion 24B.

As illustrated in FIG. 5, the lock nut 16A is engaged with one of the male threads 4202, and the lock nut 16B is engaged with the other male thread 4204.

The mouthpiece portion 22A of the present embodiment is constituted in the same manner as the mouthpiece portion 22A of the first embodiment, and the hose joint portion 24B is constituted in the same manner as the hose joint portion 24B of the second embodiment.

In the present embodiment, the female thread 2802 with which the one male thread 4202 of the adapter 42 is engaged is formed at an end portion of the mouthpiece portion 22A facing the hose joint portion 24B, and the female thread 3402 with which the other male thread 4204 is engaged is formed at an end portion of the hose joint portion 24B facing the mouthpiece portion 22A.

Specifically, in the present embodiment, the female thread 2802 that can be engaged with the male thread 4202 of the adapter 42 is formed at the inner circumferential surface of the end portion of the mouthpiece portion 22A facing the hose joint portion 24B, that is, the end portion of the mouthpiece-side nut portion 28A positioned opposite to the tube portion 26.

An annular groove 2204 is formed at an inner circumferential surface 2202, of the mouthpiece portion 22A, forming the fluid passage R, and an O-ring 30 is fitted in the annular groove 2204. The O-ring 30 of the present embodiment is provided adjacent to the female thread 2802.

In the present embodiment, the female thread 3402 that can be engaged with the male thread 4204 of the adapter 42 is formed at the inner circumferential surface of the end portion of the hose joint portion 24B facing the mouthpiece portion 22A, that is, an end portion of the joint-side nut portion 34B positioned opposite to the flange portion 36.

An annular groove 2404 is formed at an inner circumferential surface 2402, of the hose joint portion 24B, forming the fluid passage R, and the O-ring 30 is fitted in the annular groove 2404. The O-ring 30 of the present embodiment is provided adjacent to the female thread 3402.

The joining mechanism 18 that joins the mouthpiece portion 22A and the hose joint portion 24B of the present embodiment includes the rotation operation unit 44, the male threads 4202 and 4204 in the opposite directions from each other, and the female threads 2802 and 3402.

The lock mechanism 20 of the present embodiment includes the lock nuts 16A and 16B.

Next, a method for joining the mouthpiece portion 22A (first joint fitting portion 12) and the hose joint portion 24B (second joint fitting portion 14) will be described.

When the mouthpiece portion 22A and the hose joint portion 24B are joined to each other, first, the lock nut 16A is engaged with the male thread 4202 of the adapter 42, the lock nut 16B is engaged with the male thread 4204 of the adapter 42, and the lock nuts 16A and 16B are positioned in the vicinity of the rotation operation unit 44.

Subsequently, one end portion 42A of the adapter 42 is caused to face the mouthpiece-side nut portion 28A of the mouthpiece portion 22A, and the axial directions of the adapter 42 and the mouthpiece portion 22A are aligned with each other.

Then, when the one end portion 42A of the adapter 42 is inserted into the mouthpiece portion 22A, the O-ring 30 comes into elastic contact with the end portion outer circumferential surface 4206, and a gap between the end portion outer circumferential surface 4206 and the inner circumferential surface 2202 of the mouthpiece portion 22A is sealed by the O-ring 30, thereby preventing leakage of fluid from occurring between the mouthpiece portion 22A and the one end portion 42A of the adapter 42.

When the one end portion 42A of the adapter 42 is inserted into the mouthpiece portion 22A and the male thread 4202 reaches the female thread 2802 of the mouthpiece portion 22A, the mouthpiece-side nut portion 28A is operated to rotate the mouthpiece portion 22A about the axial center thereof, thereby appropriately engaging the male thread 4202 with the female thread 2802.

Another end portion 42B of the adapter 42 is caused to face the joint-side nut portion 34B of the hose joint portion 24B, and the axial directions of the adapter 42 and the hose joint portion 24B are aligned with each other.

Then, when the other end portion 42B of the adapter 42 is inserted into the hose joint portion 24B, the O-ring 30 comes into elastic contact with the end portion outer circumferential surface 4208, and a gap between the end portion outer circumferential surface 4208 and the inner circumferential surface 2402 of the hose joint portion 24B is sealed by the O-ring 30, thereby preventing leakage of fluid from occurring between the hose joint portion 24B and the adapter 42.

When the other end portion 42B of the adapter 42 is inserted into the hose joint portion 24B and the male thread 4204 reaches the female thread 3402 of the hose joint portion 24B, the joint-side nut portion 34B is operated to rotate the hose joint portion 24B about the axial center thereof, thereby appropriately engaging the male thread 4204 with the female thread 3402.

When the male thread 4202 is appropriately engaged with the female thread 2802 and the male thread 4204 is appropriately engaged with the female thread 3402, the mouthpiece portion 22A is connected to the device and the hose is attached to the hose joint portion 24B.

Then, by operating the rotation operation unit 44, the adapter 42 is rotated to adjust the distance between a specific part of the mouthpiece portion 22A and a specific part of the adapter 42 and the distance between a specific part of the hose joint portion 24B and a specific part of the adapter 42, thereby adjusting the length of the pipe joint fitting 10C. For example, the distance between an end surface of the mouthpiece-side nut portion 28A of the mouthpiece portion 22A and an end surface of the rotation operation unit 44 of the adapter 42, the end surfaces facing each other, and the distance between an end surface of the joint-side nut portion 34B of the hose joint portion 24B and an end surface of the rotation operation unit 44 of the adapter 42, the end surfaces facing each other, are adjusted. After the adjustment, the lock nut 16A is reversely rotated to be returned to a position at which the lock nut 16A comes into contact with the mouthpiece portion 22A, and the lock nut 16B is reversely rotated to be returned to a position at which the lock nut 16B comes into contact with the hose joint portion 24B, thereby fixing the pipe joint fitting 10C at a desired length.

In the present embodiment, the length of the pipe joint fitting 10C is adjustable within a range in which the male thread 4202 and the female thread 2802 can be engaged with each other and a range in which the male thread 4204 and the female thread 3402 can be engaged with each other. Accordingly, the distance from the device to the hose can be adjusted to a desired length.

As described above, the pipe joint fitting 10C of the third embodiment provides the joining mechanism 18 that joins the mouthpiece portion 22A and the hose joint portion 24B while allowing the total length of the mouthpiece portion 22A and the hose joint portion 24B to be adjusted with the interiors of the separated mouthpiece portion 22A (first joint fitting portion 12) and hose joint portion 24B (second joint fitting portion 14) in communication with each other, thus allowing the length of the pipe joint fitting 10C to be adjusted. This advantageously reduces damage to the pipe to be connected and avoids an increase in work man-hours and an increase in costs at the time of the assembly. Releasing the joining of the joining mechanism 18 allows the mouthpiece portion 22A and the hose joint portion 24B to be separated from each other, advantageously improving convenience.

The configuration of providing the lock mechanism 20 configured to lock the mouthpiece portion 22A and the hose joint portion 24B with the total length thereof adjusted allows the pipe joint fitting 10C to be fixed at a desired length, advantageously reducing damage to the pipe to be connected.

The configuration in which the pipe joint fitting 10C includes the adapter 42 having the cylindrical shape and interposed between the mouthpiece portion 22A and the hose joint portion 24B, the rotation operation unit 44 is provided at the outer circumferential portion of the intermediate portion of the adapter 42 in the longitudinal direction, male threads 4202 and 4204 in opposite directions from each other are formed at the outer circumferential portion of the adapter 42 on both sides in the longitudinal direction, the female thread 2802 with which the one male thread 4202 is engaged is formed at the end portion of the mouthpiece portion 22A facing the hose joint portion 24B, the female thread 3402 with which the other male thread 4204 is engaged is formed at the end portion of the hose joint portion 24B facing the mouthpiece portion 22A, and the joining mechanism 18 includes the rotation operation unit 44, the male threads 4202 and 4204 in the opposite directions from each other, and the female threads 2802 and 3402 advantageously constitutes the length-adjustable pipe joint fitting 10C in a simple manner.

The configuration in which the lock mechanism 20 includes the lock nuts 16A and 16B respectively engaged with the male threads 4202 and 4204 in the opposite directions from each other advantageously constitutes the lock mechanism 20 in simple manner.

The configuration in which the first joint fitting portion 12 is constituted by the mouthpiece portion 22A to be connected to the device side and the second joint fitting portion 14 is constituted by the hose joint portion 24B to which the hose is connected allows the distance between the device and the hose to be adjusted.

### First Modified Example of Third Embodiment

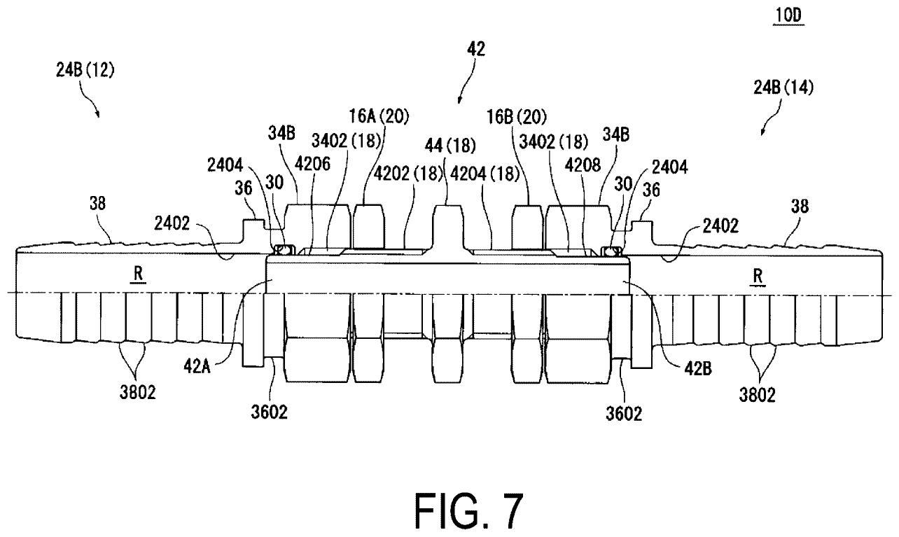

A pipe joint fitting 10D of a first modified example of the third embodiment will be described with reference to FIG. 7.

Although the mouthpiece portion 22A and the hose joint portion 24B are joined to each other via the adapter 42 in the third embodiment, the hose joint portion 24B and the hose joint portion 24B may be joined to each other via the adapter 42.

As illustrated in FIG. 7, in the pipe joint fitting 10D according to the first modified example, the mouthpiece portion 22A of the pipe joint fitting 10C of the third embodiment is replaced with the hose joint portion 24B of the third embodiment.

Therefore, in the pipe joint fitting 10D of the present modified example, both the first joint fitting portion 12 and the second joint fitting portion 14 are constituted by the hose joint portions 24B to which hoses are connected, and fluid flowing in one of the hoses is supplied to the other hose.

The same effects as those of the third embodiment are also achieved by the pipe joint fitting 10D of the first modified example described above.

In the present modified example, since the first joint fitting portion 12 and the second joint fitting portion 14 are constituted by the hose joint portions 24B to which the hoses are connected, the distance between the hoses can be adjusted.

### Second Modified Example of Third Embodiment

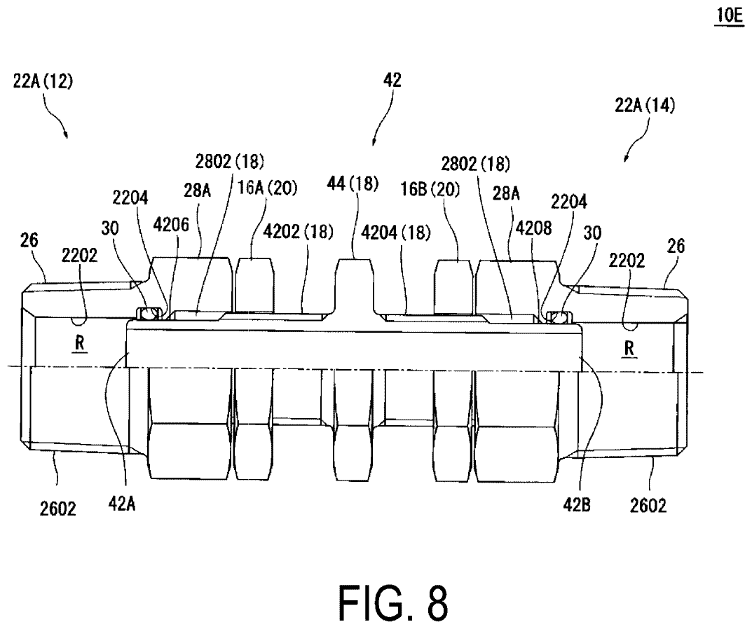

A pipe joint fitting 10E of a second modified example of the third embodiment will be described with reference to FIG. 8.

Although the mouthpiece portion 22A and the hose joint portion 24B are joined to each other via the adapter 42 in the third embodiment, the mouthpiece portion 22A and the mouthpiece portion 22A may be joined to each other via the adapter 42.

As illustrated in FIG. 8, in the pipe joint fitting 10E according to the second modified example, the hose joint portion 24B of the pipe joint fitting 10C of the third embodiment is replaced with the mouthpiece portion 22A of the third embodiment.

Therefore, in the pipe joint fitting 10E of the present modified example, both the first joint fitting portion 12 and the second joint fitting portion 14 are constituted by the mouthpiece portions 22A to be connected to the device side, and fluid discharged from one of the devices is supplied to the other crisis.

The same effects as those of the third embodiment are also achieved by the pipe joint fitting 10E of the present second modified example described above.

In the present modified example, since the first joint fitting portion 12 and the second joint fitting portion 12 are constituted by the mouthpiece portions 22A to be connected to the device side, the distance between the devices can be adjusted.

As in the above-described pipe joint fittings 10C to 10E, changing the combination of the first joint fitting portion 12 and the second joint fitting portion 14 in accordance with the intended application can connect a device and a hose, hoses to each other, or devices to each other, advantageously improving convenience.

### Fourth Embodiment

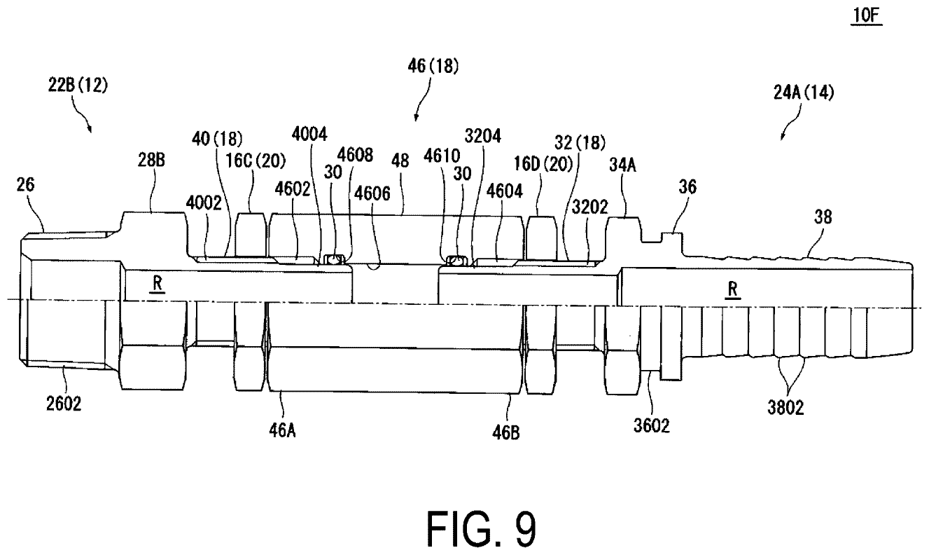

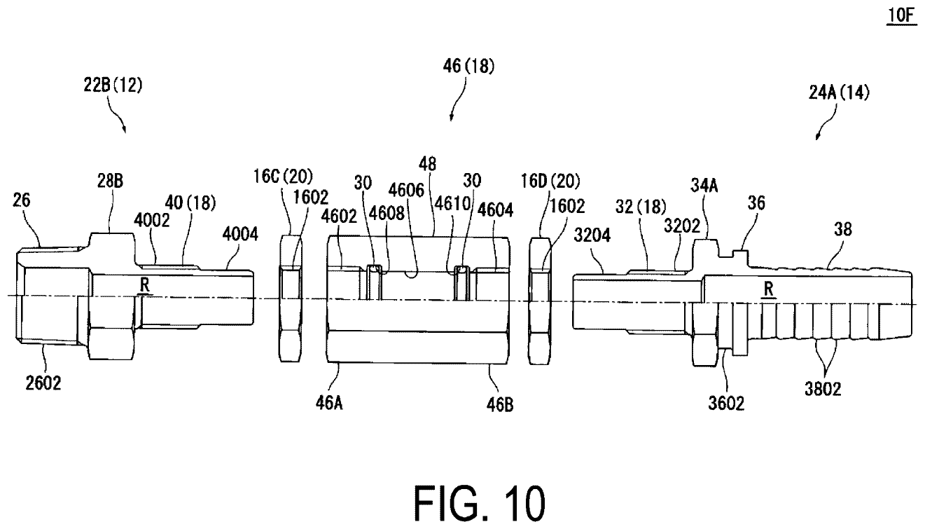

A pipe joint fitting 10F of a fourth embodiment will be described with reference to FIGS. 9 and 10.

The pipe joint fitting 10F of the fourth embodiment differs from the third embodiment in the structure of an adapter 46.

In other words, in the third embodiment, the female threads 2802 and 3402 are formed at the mouthpiece portion 22A and the hose joint portion 24B, respectively, and the male threads 4202 and 4204 are formed on both sides of the adapter 42, whereas in the fourth embodiment, female threads 4602 and 4604 are formed on both sides of the adapter 46, and the male threads 4002 and 3202 are formed at the mouthpiece portion 22B and the hose joint portion 24A, respectively.

The pipe joint fitting 10F includes the first joint fitting portion 12, the second joint fitting portion 14, the adapter 46, and lock nuts 16C and 16D, which are separated from each other as illustrated in FIG. 10.

In the pipe joint fitting 10F of the present embodiment, the first joint fitting portion 12 is constituted by the mouthpiece portion 22B to be connected to the device side, and the second joint fitting portion 14 is constituted by the hose joint portion 24A to be connected to the end portion of the hose.

The mouthpiece portion 22B of the present embodiment is constituted in the same manner as the mouthpiece portion 22B of the second embodiment, and the hose joint portion 24A is constituted in the same manner as the hose joint portion 24A of the first embodiment.

In the present embodiment, the male thread tubes 40 and 32 formed with male threads 4002 and 3202 in opposite directions from each other are respectively disposed projecting from an end portion of the mouthpiece portion 22B facing the hose joint portion 24A and an end portion of the hose joint portion 24A facing the mouthpiece portion 22B.

In other words, the male thread tubes 40 and 32, which are respectively formed with the male threads 4002 and 3202 in the opposite directions from each other are respectively disposed projecting from the end portion of the joint-side nut portion 34A positioned opposite to the flange portion 36 and the end portion of the mouthpiece-side nut portion 28B positioned opposite to the tube portion 26.

The male thread tube 40 has a cylindrical shape, and the male thread 4002 that can be engaged with the female thread 4602 of the adapter 46 is formed at the outer circumferential portion of the male thread tube 40 on the mouthpiece-side nut portion 28B side.

The front end outer circumferential surface 4004 positioned on the front end side of the male thread tube 40 is formed as a smooth surface without unevenness, and the outer diameter of the front end outer circumferential surface 4004 is formed to have a dimension insertable into an inner circumferential surface 4606 of the adapter 46.

The male thread tube 32 has a cylindrical shape, and the male thread 3202 that can be engaged with the female thread 4604 is formed at the outer circumferential portion of the male thread tube 32 on the joint-side nut portion 34A side.

The front end outer circumferential surface 3204 positioned on the front end side of the male thread tube 32 is formed as a smooth surface without unevenness, and the outer diameter of the front end outer circumferential surface 3204 is formed to have a dimension insertable into the inner circumferential surface 4606 of the adapter 46.

As illustrated in FIG. 9, the lock nut 16C is engaged with the male thread 4002 of the mouthpiece portion 22B, and the lock nut 16D is engaged with the male thread 3202 of the hose joint portion 24A.

The adapter 46 has a cylindrical shape and is interposed between the mouthpiece portion 22B and the hose joint portion 24A.

A rotation operation unit 48 configured to rotate the adapter 46 is provided at an outer circumferential portion of the adapter 46. The rotation operation unit 48 of the present embodiment is formed by an outer circumferential surface having a hexagonal cross section.

The female threads 4602 and 4604 that are threaded in opposite directions from each other and respectively engaged with the male threads 4002 and 3202 are formed at an inner circumferential portion of the adapter 46 on both sides in the longitudinal direction.

Two annular grooves 4608 and 4610 are formed at the inner circumferential surface 4606, of the adapter 46, forming the fluid passage R, and the O-rings 30 are fitted in the annular grooves 4608 and 4610, respectively. The O-rings 30 of the present embodiment are provided adjacent to the female threads 4602 and 4604, respectively.

The joining mechanism 18 of the present embodiment that joins the mouthpiece portion 22B and the hose joint portion 24A includes the male thread tubes 40 and 32 and the adapter 46.

The lock mechanism 20 of the present embodiment includes the lock nuts 16C and 16D.

Next, a method for joining the mouthpiece portion 22B (first joint fitting portion 12) and the hose joint portion 24A (second joint fitting portion 14) will be described.

When joining the mouthpiece portion 22B and the hose joint portion 24A, first, the lock nut 16C is engaged with the male thread 4002 of the mouthpiece portion 22B and positioned in the vicinity of the mouthpiece-side nut portion 28B, and the lock nut 16D is engaged with the male thread 3202 of the hose joint portion 24A and positioned in the vicinity of the joint-side nut portion 34A.

Subsequently, the male thread tube 40 of the mouthpiece portion 22B is caused to face one end portion 46A of the adapter 46, and the axial directions of the mouthpiece portion 22B and the adapter 46 are aligned with each other.

Then, when the male thread tube 40 of the mouthpiece portion 22B is inserted into the adapter 46, the O-ring 30 comes into elastic contact with the front end outer circumferential surface 4004, and a gap between the front end outer circumferential surface 4004 and the inner circumferential surface 4606 of the adapter 46 is sealed by the O-ring 30, thereby preventing leakage of fluid from occurring between the mouthpiece portion 22B and the one end portion 46A of the adapter 46.

When the male thread tube 40 is inserted into the adapter 46 and the male thread 4002 reaches the female thread 4602 of the adapter 46, the mouthpiece-side nut portion 28B is operated to rotate the mouthpiece portion 22B about the axial center thereof, thereby appropriately engaging the male thread 4002 with the female thread 4602.

The male thread tube 32 of the hose joint portion 24A is caused to face another end portion 46B of the adapter 46, and the axial directions of the hose joint portion 24A and the adapter 46 are aligned with each other.

Then, when the male thread tube 32 of the hose joint portion 24A is inserted into the adapter 46, the O-ring 30 comes into elastic contact with the front end outer circumferential surface 3204, and a gap between the front end outer circumferential surface 3204 and the inner circumferential surface 4606 of the adapter 46 is sealed by the O-ring 30, thereby preventing leakage of fluid from occurring between the hose joint portion 24A and the adapter 46.

When the male thread tube 32 is inserted into the adapter 46 and the male thread 3202 reaches the female thread 4604 of the adapter 46, the joint-side nut portion 34A is operated to rotate the hose joint portion 24A about the axial center thereof, thereby appropriately engaging the male thread 3202 with the female thread 4604.

When the male thread 4002 is appropriately engaged with the female thread 4602 and the male thread 3202 is appropriately engaged with the female thread 4604, the mouthpiece portion 22B is connected to the device and the hose is attached to the hose joint portion 24A.

Then, by operating the rotation operation unit 48, the adapter 46 is rotated to adjust the distance between a specific part of the mouthpiece portion 22B and a specific part of the adapter 46 and the distance between a specific part of the hose joint portion 24A and a specific part of the adapter 46, thereby adjusting the length of the pipe joint fitting 10F. For example, the distance between an end surface of the mouthpiece-side nut portion 28B of the mouthpiece portion 22B and an end surface of the adapter 46, the end surfaces facing each other, and the distance between an end surface of the joint-side nut portion 34A of the hose joint portion 24A and an end surface of the adapter 46, the end surfaces facing each other, are adjusted. After the adjustment, the lock nut 16C is reversely rotated to be returned to a position at which the lock nut 16C comes into contact with the mouthpiece portion 22B, and the lock nut 16D is reversely rotated to be returned to a position at which the lock nut 16D comes into contact with the hose joint portion 24A, thereby fixing the pipe joint fitting 10F at a desired length.

In the present embodiment, the length of the pipe joint fitting 10F is adjustable within a range in which the male thread 4002 and the female thread 4602 can be engaged with each other and a range in which the male thread 3202 and the female thread 4604 can be engaged with each other. Accordingly, the distance from the device to the hose can be adjusted to a desired length.

As described above, the pipe joint fitting 10F of the fourth embodiment provides the joining mechanism 18 is provided that joins the mouthpiece portion 22B and the hose joint portion 24A while allowing the total length of the mouthpiece portion 22B and the hose joint portion 24A to be adjusted with the interiors of the separated mouthpiece portion 22B (first joint fitting portion 12) and hose joint portion 24A (second joint fitting portion 14) in communication with each other, thus allowing the length of the pipe joint fitting 10F to be adjusted. This advantageously reduces damage to the pipe to be connected and avoids an increase in work man-hours and an increase in costs at the time of the assembly. Further, by releasing the joining of the joining mechanism 18, the mouthpiece portion 22B and the hose joint portion 24A can be separated from each other, which is advantageous in improving convenience. The configuration of providing the lock mechanism 20 configured to lock the mouthpiece portion 22B and the hose joint portion 24A with the total length therebetween adjusted allows the pipe joint fitting 10F to be fixed at a desired length, advantageously reducing damage to the pipe to be connected.

The pipe joint fitting 10F includes the adapter 46 having the cylindrical shape and interposed between the mouthpiece portion 22B and the hose joint portion 24A, the male thread tubes 40 and 32 respectively formed with the male threads 4002 and 3202 in the opposite directions from each other are respectively disposed projecting from the end portion of the mouthpiece portion 22B facing the hose joint portion 24A and the end portion of the hose joint portion 24A facing the hose joint portion 22B, the rotation operation unit 48 is provided at the outer circumferential portion of the adapter 46, the female threads 4602 and 4604 in the opposite directions from each other respectively engaged with the male threads 4002 and 3202, are formed at the inner circumferential portion of the adapter 46 on both sides in the longitudinal direction, and the joining mechanism 18 includes the male thread tubes 40 and 32 and the adapter 46. This is advantageous in configuring the length-adjustable pipe joint fitting 10F in a simple manner.

The configuration in which the lock mechanism 20 includes the lock nuts 16C and 16D respectively engaged with the male threads 4002 and 3202 in the opposite directions from each other advantageously constitutes the lock mechanism 20 in a simple manner.

The configuration in which the first joint fitting portion 12 is constituted by the mouthpiece portion 22B to be connected to the device side and the second joint fitting portion 14 is constituted by the hose joint portion 24A to which the hose is connected allows the distance between the device and the hose to be adjusted.

### First Modified Example of Fourth Embodiment

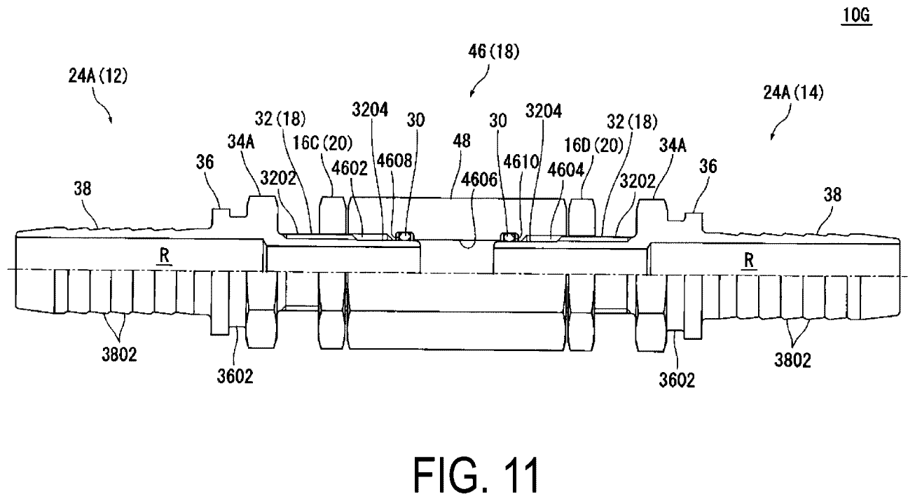

A pipe joint fitting 10G of a first modified example of the fourth embodiment will be described with reference to FIG. 11.

Although the mouthpiece portion 22B and the hose joint portion 24A are joined to each other via the adapter 46 in the fourth embodiment, the hose joint portion 24A and the hose joint portion 24A may be joined to each other via the adapter 46.

As illustrated in FIG. 11, in the pipe joint fitting 10G according to the first modified example, the mouthpiece portion 22B of the pipe joint fitting 10F of the fourth embodiment is replaced with the hose joint portion 24A of the fourth embodiment.

Therefore, in the pipe joint fitting 10G of the present modified example, both the first joint fitting portion 12 and the second joint fitting portion 14 are constituted by the hose joint portions 24A to which hoses are connected, and fluid flowing in one of the hoses is supplied to the other hose.

The same effects as those of the fourth embodiment can be achieved by the pipe joint fitting 10G of the first modified example.

In the present modified example, since the first joint fitting portion 12 and the second joint fitting portion 14 are constituted by the hose joint portions 24A to which the hoses are connected, the distance between the hoses can be adjusted.

### Second Modified Example of Fourth Embodiment

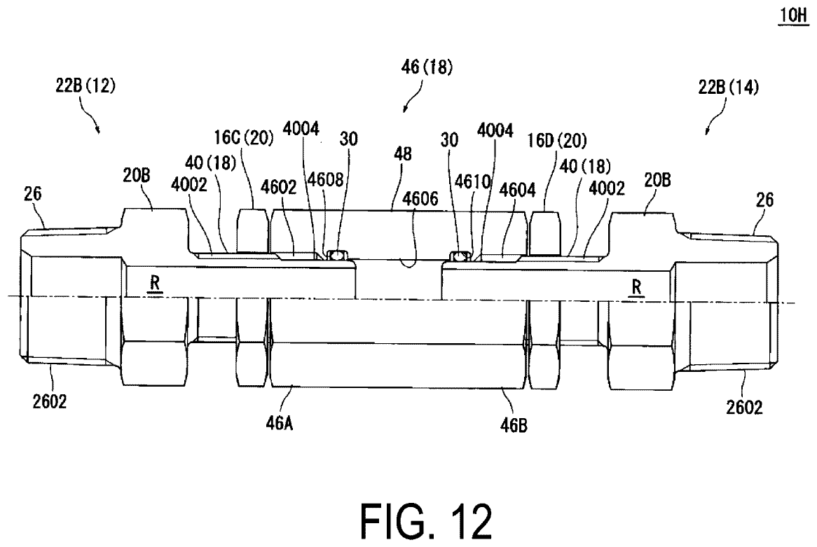

A pipe joint fitting 10H of a second modified example of the fourth embodiment will be described with reference to FIG. 12.

Although the mouthpiece portion 22B and the hose joint portion 24A are joined to each other via the adapter 46 in the fourth embodiment, the mouthpiece portion 22B and the mouthpiece portion 22B may be joined to each other via the adapter 46.

As illustrated in FIG. 12, in the pipe joint fitting 10H according to the second modified example, the hose joint portion 24A of the pipe joint fitting 10F of the fourth embodiment is replaced with the mouthpiece portion 22B of the fourth embodiment.

Therefore, in the pipe joint fitting 10H of the present modified example, both the first joint fitting portion 12 and the second joint fitting portion 12 are constituted by the mouthpiece portions 22B to be connected to the device side, and fluid discharged from one of the devices is supplied to the other crisis.

The same effects as those of the fourth embodiment can be achieved by the pipe joint fitting 10H of the present second modified example.

In the present modified example, when the first joint fitting portion 12 and the second joint fitting portion 14 are constituted by the mouthpiece portions 22B to be connected to the device side, the distance between the devices can be adjusted.

As in the above-described pipe joint fittings 10F to 10H, changing the combination of the first joint fitting portion 12 and the second joint fitting portion 14 in accordance with the intended application can connect a device and a hose, hoses to each other, or devices to each other, advantageously improving convenience.

### REFERENCE SIGNS LIST

10A to 10H Pipe joint fitting
12 First joint fitting portion
14 Second joint fitting portion
16, 16A to 16D Lock nut
18 Joining mechanism
20 Lock mechanism
22A, 22B Mouthpiece portion
24A, 24B Hose joint portion
26 Tube portion
28A, 28B Mouthpiece-side nut portion
30 O-ring
32, 40 Male thread tube
34A, 34B Joint-side nut portion
36 Flange portion
38 Cylindrical portion
42, 46 Adapter
44, 48 Rotation operation unit
R Fluid passage

1. A pipe joint fitting, comprising:
a first joint fitting portion; and
a second joint fitting portion and
connecting fluid passages;
the pipe joint fitting comprising a joining mechanism configured to join the first joint fitting portion and the second joint fitting portion while allowing a total length of the first joint fitting portion and the second joint fitting portion to be adjusted with the first joint fitting portion and the second joint fitting portion joined to each other and with interiors of the first joint fitting portion and the second joint fitting portion in communication with each other.

2. The pipe joint fitting according to claim 1, comprising
a lock mechanism configured to lock the first fitting joint portion and the second joint fitting portion with the total length thereof adjusted.

3. The pipe joint fitting according to claim 1, wherein
a male thread tube is disposed projecting from one of an end portion of the second joint fitting portion facing the first joint fitting portion or an end portion of the first joint fitting portion facing the second joint fitting portion, and a female thread engageable with the male thread tube is formed at the other of the end portions, and
the joining mechanism comprises the male thread tube and the female thread.

4. The pipe joint fitting according to claim 3, wherein
a lock nut is engaged with the male thread tube, and
a lock mechanism configured to lock the first joint fitting portion and the second joint fitting portion with a total length thereof adjusted comprises the lock nut.

5. The pipe joint fitting according to claim 1, comprising
an adapter having a cylindrical shape and interposed between the first joint fitting portion and the second joint fitting portion, wherein
a rotation operation unit configured to rotate the adapter is provided at an outer circumferential portion of an intermediate portion of the adapter in a longitudinal direction, and male threads in opposite directions from each other are formed at the outer circumferential portion of the adapter on both sides in the longitudinal direction,
a female thread to be engaged with one of the male threads in the opposite directions from each other is formed at an end portion of the second joint fitting portion facing the first joint fitting portion,
a female thread to be engaged with the other of the male threads in the opposite directions from each other is formed at an end portion of the first joint fitting portion facing the second joint fitting portion, and
the joining mechanism comprises the rotation operation unit, the male threads in the opposite directions from each other, and the female threads.

6. The pipe joint fitting according to claim 5, wherein
a lock nut is engaged with each of the male threads in the opposite directions from each other, and
a lock mechanism configured to lock the first joint fitting portion and the second joint fitting portion with a total length thereof adjusted comprises the lock nut.

7. The pipe joint fitting according to claim 1, comprising
an adapter having a cylindrical shape and interposed between the first joint fitting portion and the second joint fitting portion, wherein
male thread tubes formed with male threads in opposite directions from each other are each disposed projecting from an end portion of the second joint fitting portion facing the first joint fitting portion and an end portion of the first joint fitting portion facing the second joint fitting portion,
a rotation operation unit configured to rotate the adapter is provided at an outer circumferential portion of the adapter,
female threads in opposite directions from each other engaged with the male threads are formed at an inner circumferential portion of the adapter on both sides in a longitudinal direction, and
the joining mechanism comprises the male thread tubes and the adapter.

8. The pipe joint fitting according to claim 7, wherein
a lock nut is engaged with each of the male threads in the opposite directions from each other, and
a lock mechanism configured to lock the first joint fitting portion and the second joint fitting portion with a total length thereof adjusted comprises the lock nut.

9. The joint fitting according to claim 1, wherein
the first joint fitting portion is a mouthpiece portion to be connected to a device side, and
the second joint fitting portion is a hose joint portion to which a hose is connected.

10. The joint fitting according to claim 1, wherein
the first joint fitting portion and the second joint fitting portion are hose joint portions to which hoses are connected.

11. The joint fitting according to claim 1, wherein
the first joint fitting portion and the second joint fitting portion are mouthpiece portions to be connected to a device side.
